(19) United States
(12) Patent Application Publication
(10) Pub. No.: US 2016/0250824 A1
(43) Pub. Date: Sep. 1, 2016

(54) 3D Spacer Fabric and Unbroken Loop Pile Fabric Laminated Composite Material

(71) Applicant: AccuMED Corp., Mocksville, NC (US)

(72) Inventors: Amirtharajan Krishnasamy, West Seneca, NY (US); Michael DiMeo, Buffalo, NY (US)

(73) Assignee: AccuMED Corp., Mocksville, NC (US)

(21) Appl. No.: 15/154,197

(22) Filed: May 13, 2016

Related U.S. Application Data
(63) Continuation of application No. 14/515,586, filed on Oct. 16, 2014.

(51) Int. Cl. B32B 5/26; B32B 7/12; D04B 1/02; B32B 5/02

(52) U.S. Cl. CPC B32B 5/26; B32B 5/026; B32B 7/12; D04B 1/02; B32B 2307/724; B32B 2535/00; B32B 2262/0269; B32B 2262/0276; B32B 2262/0292; B32B 2262/14; D10B 2509/00; D10B 2403/033

(57) ABSTRACT

The present invention relates to a laminated composite material and, more particularly, to a laminated composite material that can include, but is not limited to, an unbroken loop pile fabric (UBL fabric) layer laminated to at least one side/surface of a spacer fabric (3D knit fabric) layer.

### CROSS-REFERENCE TO RELATED APPLICATION

The present application is a continuation of applicant's co-pending U.S. application Ser. No. 14/515,586, filed Oct. 16, 2014, the entirety of which is hereby incorporated by reference.

### BACKGROUND OF THE INVENTION

1. Field of the Invention

The present invention relates to a laminated composite material and, more particularly, to a laminated composite material that can include, but is not limited to, an unbroken loop pile fabric (UBL fabric) layer laminated to at least one side/surface of a spacer fabric (3D knit fabric) layer.

2. Description of the Related Art

In medical device soft goods industries like orthopedic and sleep apnea products, laminated composites are widely used to build products which are utilized to hold medical devices or provide compression support to the users. The conventional/traditional laminated composite is typically a three layer or five layer material which consists of an open cell polyurethane foam, flame laminated with fabrics on either sides. This laminated composite has been used in the orthopedic or sleep apnea industries for many years due to its exceptional properties like breathability, stretch and recovery, durability and skin friendliness.

The majority of the exceptional properties of conventional laminated composites are contributed by the core material which is high density elastomeric polyurethane foam. The physical properties of the laminated composite can be changed by modifying the density of the foam, and type of fabric used on either side of the composite. An unbroken loop pile fabric (UBL fabric) is used on one side of the foam or on either side of the composite which enables it to engage to molded/woven hook fasteners like Velcro®, Paiho etc. These laminated composites enable soft goods manufactures to use various technologies like cutting, sewing and welding to convert the laminated rolled goods as finished medical products. This versatile nature of the laminated composites has enabled it to succeed in the market for many years.

In some laminates, such as Breath-O-Prene®, a hook-engageable fabric is laminated to a polyurethane foam on one side, and fabric on the other. Silver-Tec® brand laminate is similar to a polyurethane laminate and contains silver to provide anti-microbial properties. Despite the perforations in these products, air permeation is limited.

In some other cases an open, net-like fabric is provided, as in the Powerstretch-Rx® product available from Polartec and used on some Futuro® brand straps made by Biersdorf Inc. of Wilton, Conn., USA. This fabric is a non-hook-engageable knit spacer fabric with top and bottom fabric layers and yarns knited between the layers to space them apart. It is said to have moisture-releasing properties. Other brace straps, like the Futuro® Infinity precision-fit braces, advertise enhanced breathability and anti-microbial support. These laminates are foam laminates with a soft interior skin contact fabric laminated to a foam core, then laminated to an outer layer of hook-engageable loop material with holes on one side of the laminate that allow for some air and moisture transport.

Description of the Related Art Section Disclaimer: To the extent that specific patents/publications/products are discussed above in this Description of the Related Art Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety(ies).

### SUMMARY OF THE INVENTION

Various embodiments of the present invention may be advantageous in that they may solve or reduce one or more of the potential problems and/or disadvantages with conventional laminated composites discussed above.

Various embodiments of the present invention may exhibit one or more of the following objects, features and/or advantages:

It is therefore a principal object and advantage of the present invention to provide an alternative laminated composite material that delivers a variety of the same or better quality physical properties such as increased airflow, breathability, stretch, recovery light weight etc. as compared with conventional laminated composites.

In accordance with the foregoing principal object and advantage, an embodiment of the present invention is directed to a laminated composite material that can include, but is not limited to, an unbroken loop pile fabric layer laminated to at least one side/surface of a spacer fabric (3D knit fabric) layer. The unbroken loop pile fabric layer can include, but is not limited to, style #72000 UBL fabric from Darlington Fabrics, Rhode Island, and Style #JL6204 UBL from Guilford Fabrics, Argentina. The spacer fabric (3D knit fabric) can include, but is not limited to, DNB series of 3D spacer fabric from Apex Mills, New York, and Hiflow series of 3D spacer fabrics from Highland Industries, North Carolina. As noted above, the unbroken loop pile fabric (UBL fabric) can be used to enable the laminated composite material to engage with molded/woven hook fasteners like Velcro®, Paiho etc. There is no spacer fabric which has raised unbroken loop pile at least on one side available on the market for enabling such a combination to engage with the molded or woven hook fastener like Velcro.

### BRIEF DESCRIPTION OF THE DRAWINGS

The present invention will be more fully understood and appreciated by reading the following Detailed Description in conjunction with the accompanying drawings, in which:

FIG. 1a is a side view schematic illustration of a laminated composite material in accordance with an embodiment of the present invention.

FIG. 1b is a perspective exploded view of laminated composite material in accordance with an embodiment of the present invention.

FIG. 2a is a picture showing a side perspective view of a laminated composite material in accordance with an embodiment of the present invention.

FIG. 2b is a perspective exploded view of laminated composite material in accordance with an embodiment of the present invention.

FIG. 3 is a perspective view of a 3 layer conventional/traditional composite material.

### DETAILED DESCRIPTION

The present invention will be more fully understood and appreciated by reading the following Detailed Description in conjunction with the accompanying drawings, wherein like reference numerals refer to like components. Certain dimensions may be listed in some of the drawings or described herein, however, these dimensions are exemplary and embodiments of the present invention are not limited to these dimensions.

As described herein and shown in the Figures, a flexible and breathable fabric laminate is formed from a spacer fabric layer laminated to a knit Unbroken loop(UBL) pile fabric layer; the UBL fabric layer having exposed hook-engage able loops and the other ‘spacer fabric’ layer providing a skin contact surface. The fabrics can be bonded together by a lamination process. The knit spacer fabric layer can provide air permeability and the knit loop pile fabric layer can enable engagement with a hook material.

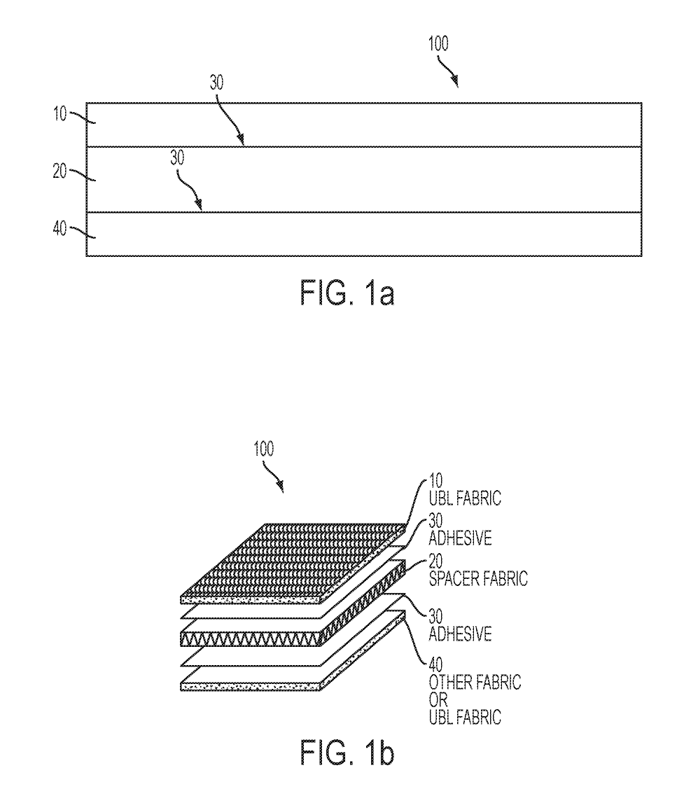

As shown in FIG. 1a, a side view schematic illustration of a laminated composite material 100 is illustrated, according to an embodiment of the present invention. The laminated composite material 100 can include a first layer comprising a knit UBL fabric layer 10 laminated via adhesive 30 to a first side of a spacer fabric layer 20. Also, shown is a second optional UBL fabric layer 40 (or other fabric as may be desired) laminated via adhesive 30 to a second side of a spacer fabric layer 20.

Turing to FIG. 1b, a perspective exploded view of laminated composite material 100 is provided. The same elements of the laminated composite material 100 shown in FIG. 1a are shown in FIG. 1b.

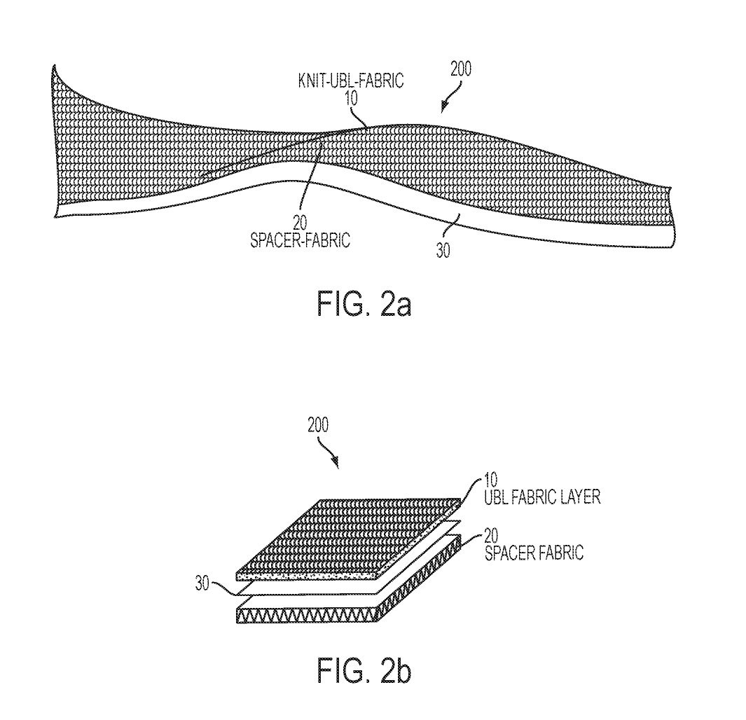

Turning to FIG. 2a, a picture showing a side perspective view of a laminated composite material 200 is provided, according to an embodiment of the present invention. As discussed with respect to FIG. 1 with respect to laminated composite material 100, the laminated composite material 200 can include a first layer comprising a knit UBL fabric 10 laminated via adhesive 30 to a first side of a spacer fabric layer 20.

Turing to FIG. 2b, a perspective exploded view of laminated composite material 200 is provided. The same elements of the laminated composite material 200 shown in FIG. 2a are shown in FIG. 2b.

The laminated composite material of an embodiment of the present invention is designed to deliver similar or better properties as the traditional laminated composites based on the unique structure described herein. A wide range of physical properties can be obtained from the composite by changing the UBL fabric or the spacer fabric, as discussed in the Example below.

Advantages of embodiments of the invention are illustrated by the Example section below. However, the particular materials and amounts thereof recited in the Examples, as well as other conditions and details, are to be interpreted to apply broadly in the art and should not be construed to unduly restrict or limit the invention in any way.

### EXAMPLE 1

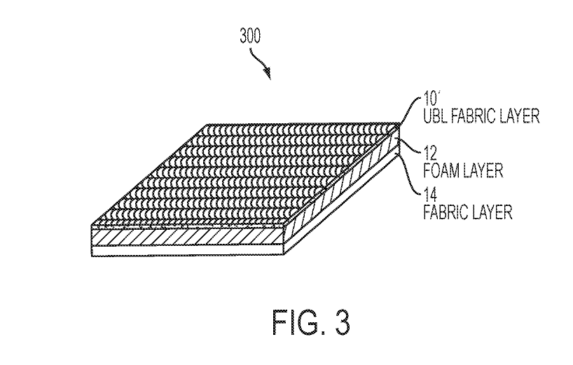

This Example describes testing of two embodiments of the invention—Type 1 and Type 2 UBL/3D Spacer Fabric laminated composites vs. a 3 layer conventional/traditional composite style 6204 UBL fabric from Guilford (Argentina) (see FIG. 3, showing perspective view of a 3 layer conventional/traditional composite material 300 with a UBL fabric layer 10′, foam layer 12, and a fabric layer 14). The testing and experimental details performed which yielded the results discussed herein were performed pursuant to ASTMID standards, as should be understood by those of skill in the art.

The Type 1 composite is made of a first layer of UBL fabric—88% nylon, 12% spandex yarn warp knit fabric which weighs about 5.5 to 6.5 oz. per sq. yard with unbroken loop pile on one side, and a second layer of 3D spacer fabric—85% nylon, 15% spandex yarn spacer fabric which weighs about 310 grams per yard. The Type 2 composite made of a first layer of UBL fabric—100% yarn warp knit fabric which weighs about 5.5 to 6.5 oz. per sq. yard with unbroken loop pile on one side, and a second layer of 3D spacer fabric—100% polyester fabric which weighs 930 grams per yard. The 3 layer composite is made of a first layer of 88% nylon, 12% spandex yarn warp knot fabric which weighs 5.5 to 6.5 oz. per sq. yard with unbroken loop pile on one side, a second layer of polyurethane foam with 10 lb per cu. ft. density, and a third layer of 85% nylon, 15% spandex yarn warp knot fabric which weighs about 5.5 to 6.5 oz. per sq. yard.

The results of the experiment are listed in Table 1 below:

TABLE 1

| | | UBL fabric/10# polyurethane | UBL/Spacer | UBL/Spacer |
|---|---|---|---|---|
| | Test | foam/Nylon spandex lamianted | fabric laminated | fabric laminated |
| Properties | Standard/Units | composite - 3 layer composite | composite - Type 1 | composite - Type 2 |
| Stretch % | ASTMD 6614/% | 28.1 | 27.2 | 11.3 |
| Growth % | ASTMD 6614/% | 1.3 | 1.4 | 3.1 |
| Thickness | (MM) | 3.15 | 3.5 | 4.5 |
| Hardness | Asker C | 5 to 10 | 5 to 10 | 5 to 10 |
| Air permeability | ASTMD 737/ | 5.49 | 23.48 | 18.21 |
| | (Ft3/min/ft2) | | | |
| Compression set - % | ASTMD 1056/% | 2.65% | 4.21% | 6.28% |
| not recovered | | | | |

The results show that a change in materials to produce the Type 1 and Type 2 UBL/3D Spacer Fabric composites helps to alter the physical properties like stretch %, growth %, air permeability and thickness in these composites. Hence, it makes the composites of embodiments of the present invention versatile in achieving physical properties as required by the end application by changing the UBL fabric/spacer materials, and equaling or surpassing some of the physical properties as compared to the 3 layer conventional/traditional composite.

### EXAMPLE 2

This Example describes various types of lamination processes that can be used to add the UBL layer to the spacer fabric layer and to enable the spacer fabric layer to engage with a loop, in accordance with an embodiment of the present invention. As discussed herein, the 3D spacer fabric doesn't have a molded/woven hook fastener compatible surface to make it engage with the hook fasteners. It is the UBL fabric that has the unbroken loop (UBL) on one side which is compatible with molded/woven hook fasteners. A lamination process according to an embodiment of the present invention is performed to physically adhere the UBL fabric to the spacer fabric to enable the resultant composite to be compatible with molded/woven hook fasteners.

A variety of adhesive laminations can be used including the following: (1) Web adhesive can be applied between the UBL/3D spacer fabric to adhere the UBL and 3D spacer fabric; (2) Hot melt adhesive can be applied between the UBL/3D spacer fabric to adhere the UBL and 3D spacer fabric; (3) Pressure sensitive adhesive can be applied between the UBL/3D spacer fabric to adhere the UBL and 3D spacer fabric; (4) Adhesives films can be applied between the UBL/3D spacer fabric to adhere the UBL and 3D spacer fabric; and (5) Froth foam can be applied between the UBL/3D spacer fabric to adhere the UBL and 3D spacer fabric.

Flame lamination can also be used such as the following: (1) Cellular structured foam can be molten with a flame laminator which is used as an adhesive to bond the UBL and the 3D spacer fabric; and (2) Thin film can be molten with a flame laminator which can be used as an adhesive to bond the UBL and the 3D spacer

The laminated composite material can be used, for example, in the medical device and/or apparel industries. For example, sleep apnea headgear and orthopedic braces can be a major application of the composite material of an embodiment of the present invention. Sleep apnea headgear typically requires a hook to engage with the loop on the composite material to keep the mask in place. The laminated composite material of an embodiment of the present invention can replace the traditional foam composite materials on these medical products thereby providing more breathability and comfort to a user's skin.

While several embodiments of the invention have been discussed, it will be appreciated by those skilled in the art that various modifications and variations of the present invention are possible. Such modifications do not depart from the spirit and scope of the present invention.

What is claimed is:

1. A laminated composite material comprising:
a first layer comprising a spacer fabric, wherein said first layer further comprises a first surface and a second surface; and
a second layer comprising an unbroken loop pile fabric laminated to said first surface of said first layer.

2. The laminated composite material of claim 1, wherein said second layer is compatible to engage with a third layer of molded or woven hook fasteners.

3. The laminated composite material of claim 1, wherein said second layer is laminated to said first surface of said first layer via an adhesive selected from the group consisting of web adhesive, hot melt adhesive, pressure sensitive adhesive, an adhesive film, water based adhesive, solvent based adhesive, and froth foam.

4. The laminated composite material of claim 1, wherein said second layer is laminated to said first surface of said first layer via flame lamination.

5. The laminated composite material of claim 4, wherein said flame lamination is selected from a group consisting of molten cellular structured foam and molten thin film.
